(19) United States
(12) Patent Application Publication
(10) Pub. No.: US 2010/0325031 A1
(43) Pub. Date: Dec. 23, 2010

(54) METHOD AND SYSTEM FOR TRADING FINANCIAL ASSETS

(75) Inventors: MICHAEL ALAN KAHAN, Round Rock, TX (US); Ralph Bruce Ferguson, Round Rock, TX (US)

Correspondence Address: RATNERPRESTIA, P.O. BOX 980, VALLEY FORGE, PA, 19482, US

(73) Assignee: Penson Worldwide, Inc., Dallas, TX (US)

(21) Appl. No.: 12/818,329

(22) Filed: Jun. 18, 2010

Related U.S. Application Data
(60) Provisional application No. 61/218,245, filed on Jun. 18, 2009.

(51) Int. Cl. G06Q 40/00

(52) U.S. Cl. 705/37

(57) ABSTRACT

Systems and methods for trading financial assets are disclosed. Financial assets may be traded by locally providing quotes for a financial asset in a foreign currency, locally receiving orders for the financial asset in the foreign currency, and locally filling the orders in the foreign currency. Hedged quotes for the financial assets may be developed for trading, in a first currency, financial assets priced in a second currency.

### RELATED APPLICATIONS

This application claims the benefit of the filing date of U.S. provisional application No. 61/218,245, filed Jun. 18, 2009, the contents of which are incorporated fully herein by reference.

### FIELD

The present invention concerns financial methods and systems. In particular, the present invention concerns methods and systems for trading financial assets priced in foreign currencies on a local trading platform and methods and systems for trading financial assets priced in a first currency pursuant to orders priced in a second currency.

### BACKGROUND

Many investors located in the United States invest in foreign financial assets, e.g., foreign debt and equity securities, futures, options, commodities, etc. Although the risks and rewards of financial assets traded on foreign exchanges may be similar to those traded on U.S. exchanges, they are frequently magnified from the view of an investor in the United States. Specifically, from the vantage point of U.S. investors, foreign financial assets are often subject to wider price swings.

There are a variety of reasons for the wider price swings. One reason is the effect of political instability which affects the prices of the foreign financial assets in the foreign currency. Another is the fact that many foreign markets are smaller than the U.S. markets. Thus, their assets may be more thinly traded. Yet another reason is that the exchange rates of currencies (U.S. dollars to foreign currency and vice versa) change, thereby giving rise to currency risk.

An investor located in the United States and wanting to purchase financial assets, e.g., stocks, bonds, etc., traded on a foreign exchange has several conventional options. One option is to purchase shares in an exchange traded fund (ETF) that purchases one or more underlying foreign financial assets, e.g., foreign stocks, bonds, etc. The shares of the ETF are traded on exchanges in the United States. The underlying assets of the ETF provide dividends and interest payments in one or more foreign currencies, and the ETF distributes the dividends or interest payments, converted to U.S. dollars in the foreign exchange (FX) market, to each shareholder of the ETF.

Another option for an investor located in the United States is to purchase American Depositary Receipts (ADRs). ADRs represent shares in foreign companies. A foreign company, desiring to issue equity shares on an exchange in the U.S., deposits shares in a U.S. depository bank. The bank bundles the shares into groups and reissues them as ADRs, which are traded on U.S. exchanges. ADRs are priced in U.S. dollars. They pay dividends in U.S. dollars, converted in the FX markets from the foreign-currency denominated dividends paid by the foreign company.

Yet another option is to purchase the foreign financial assets themselves, e.g., stocks, bonds, etc., traded on a foreign exchange. Typically, a U.S. investor wanting to purchase a foreign stock contacts his broker in the U.S. to arrange for the purchase. The U.S. broker contacts a broker located in the foreign country where the foreign stock is traded to execute the trade. The foreign trade is settled in the foreign currency, and the foreign stock is delivered, by the foreign broker, to the U.S. broker, who delivers it to the investor in the United States.

### SUMMARY

In accordance with an aspect of the present invention, there is provided a method for trading financial assets on a computer system of a local trading platform in a currency foreign to the local trading platform. The method includes providing, by the computer system of the local trading platform, quotes of the financial assets in the foreign currency. The method also includes receiving, by the computer system of the local trading platform, an order for one or more of the financial assets in the foreign currency and filling, by the computer system of the local trading platform, the order by matching the order in the foreign currency to one or more counterparty orders in the foreign currency.

In accordance with another aspect of the present invention, there is provided a method for trading, in a first currency, a financial asset ordered in a second currency, where the first currency is different from the second currency. The method includes receiving, in a computer system of a trading platform, at least one substantially real-time series of currency conversion quotes for converting between the first currency and the second currency. The method further includes determining, by the computer system of the trading platform, a hedged quote for the financial asset in the first currency by applying a currency conversion model to the at least one substantially real-time series of currency conversion quotes and a substantially real-time series of quotes for the financial asset priced in the second currency. The hedged quote is provided by the computer system of the trading platform. The method receives an order for the financial asset by the computer system of the trading platform. The order is priced in the first currency.

### BRIEF DESCRIPTION OF THE DRAWINGS

The invention is best understood from the following detailed description when read in connection with the accompanying drawings. Included in the drawings are the following figures:

FIG. 1 is a block diagram illustrating a system for offering, on a local trading platform, foreign financial assets priced in a foreign currency, in accordance with an exemplary embodiment of the present invention;

FIG. 2 illustrates a trading system in which financial assets are traded on a local trading platform in a foreign currency, wherein an investor places orders for the financial assets with a broker in the foreign currency, in accordance with an exemplary embodiment of the present invention;

FIG. 3 illustrates a flow chart of exemplary steps of a method performed by the investor illustrated in FIG. 2, in accordance with an exemplary embodiment of the present invention;

FIG. 4 illustrates a flow chart of exemplary steps of a method performed by the broker illustrated in FIG. 2, in accordance with an exemplary embodiment of the present invention;

FIG. 5 illustrates a flow chart of exemplary steps of a method performed by the local trading platform illustrated in FIG. 2, in accordance with an exemplary embodiment of the present invention;

FIG. 6 illustrates a trading system in which financial assets are traded in a market in a trading platform in a first currency, wherein an investor places orders for the financial assets with a broker in a second currency and the local trading platform operates a currency conversion model to provide hedged quotes in the second currency, in accordance with an exemplary embodiment of the present invention;

FIG. 7 illustrates a flow chart of exemplary steps of a method performed by the investor illustrated in FIG. 6, in accordance with an exemplary embodiment of the present invention;

FIG. 8 illustrates a flow chart of exemplary steps of a method performed by the broker illustrated in FIG. 6, in accordance with an exemplary embodiment of the present invention;

FIG. 9 illustrates a flow chart of exemplary steps of a method performed by the trading platform illustrated in FIG. 6, in accordance with an exemplary embodiment of the present invention;

FIG. 9A illustrates a flow chart of exemplary steps performed by the trading platform illustrated in FIG. 6 when filling a limit order, in accordance with an exemplary embodiment of the present invention;

FIG. 10 illustrates a function block diagram for the trading system illustrated in FIG. 2, in accordance with an exemplary embodiment of the present invention; and

FIG. 11 illustrates a function block diagram for the trading system illustrated in FIG. 6, in accordance with an exemplary embodiment of the present invention.

### DETAILED DESCRIPTION

Conventional methods and systems for investing in foreign financial assets suffer from numerous disadvantages. As described below, the conventional methods and systems may not provide sufficient options to an investor seeking to own foreign financial assets. Further, the conventional methods and systems may force the investor into a particular position regarding a currency, when, in fact, the investor desires another position regarding the currency. For example, the investor may be forced into a position that would benefit from appreciation of a certain currency, but the investor may instead desire to speculate against appreciation of that currency.

The ETFs described above typically represent a basket of foreign stocks or bonds. For example, an ETF may purchase stocks in multiple foreign mining companies, multiple foreign small cap stocks, etc. Typically, ETFs do not limit their holdings to a particular class of stocks or type of debt in one company. Further, the number of ETFs from which to choose is significantly smaller than the number of classes of stocks and bonds traded. Thus, ETFs may not provide investors with sufficient options for investing in a particular class of shares or type of debt in a foreign company.

ETFs that are available for foreign equity shares may, nevertheless, be undesirable for investors in the United States. Specifically, ETFs expose holders of the ETFs' shares to a particular currency-risk position that they might find undesirable. The reasons are explained below.

The foreign equity shares underlying ETFs pay dividends in a foreign currency. These dividends are converted to U.S. dollars by the ETFs for distribution to the shareholders of the ETFs. Although the foreign company represented in the foreign equity shares may issue the same dividend from quarter to quarter over a certain period, the dividend, priced in U.S. dollars, paid to the U.S. investor might fluctuate as the currency exchange rate fluctuates. An investor may not want the dividends to be converted to U.S. dollars as he might want to speculate against the U.S. dollar. Further, the investor may not want to conduct transactions (buys and sells) in U.S. dollars to purchase ETFs in the United States. Thus, ETFs may not be desirable to an investor as they force the investor into a particular currency position with respect to the U.S. dollar.

The ADRs described above suffer from many of the same problems as ETFs. An ADR for particular foreign equity shares is only available in the United States if a depository bank in the United States has such foreign equity shares on deposit. Not all classes of equities traded on foreign exchanges have shares on deposit at depository banks in the U.S. Thus, ADRs may not provide investors with sufficient options for investing in a particular class of shares. Additionally, ADRs force investors into a particular currency position with respect to the U.S. dollar as they are traded in the United States in U.S. dollars and the depository banks convert distributed dividends to U.S. dollars. Such position may not be desirable to the investor.

Finally, purchasing foreign financial assets directly is an option not available to all investors. Foreign financial assets traded in foreign countries in a foreign currency are not listed and traded on exchanges in the United States in the foreign currency. In order for an investor, located in the United States, to purchase foreign financial assets traded on a foreign exchange, the investor typically makes contact with a broker in the United States who makes contact with a broker in the foreign country where the foreign exchange is located. Not all brokers in the United States, however, have relationships with foreign brokers. Thus, the option of placing orders for foreign financial assets traded in foreign markets in a foreign currency may not be available to all investors in the United States. Furthermore, for investors who do have brokers that have relationships with foreign brokers, purchasing or selling foreign financial assets requires two broker fees, one for the U.S. broker and one for the foreign broker. Such double fees may not be desirable.

An investor seeking exposure to currency risk to speculate on or hedge against changes in exchange rates typically trades currencies in the FX market or currency futures in the futures markets. However, an investor may not want to limit his exposure to currency movements by operating in the FX or currency futures markets only. Rather, the investor may want to obtain a desired level of exposure to currency movements in financial assets having their own asset-price risk. In other words, the investor may want to invest in a foreign financial asset, e.g., a foreign equity security, a foreign debt security, etc., that exposes him to both asset-price risk as well as a particular, desired currency risk position.

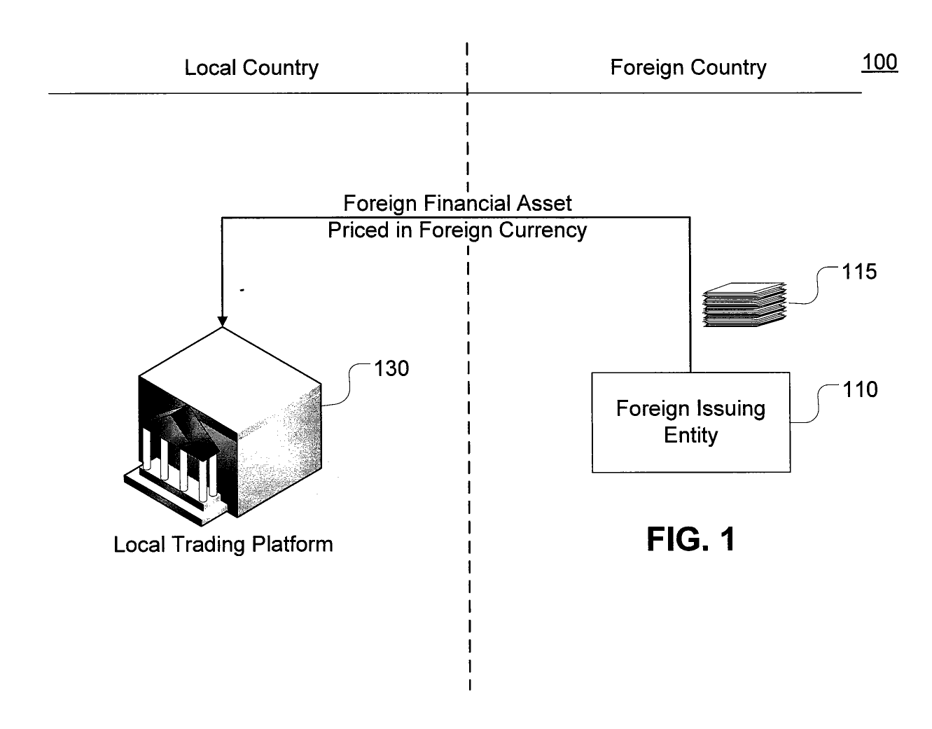

Referring now to FIG. 1, there is illustrated an embodiment of a system, generally designated as 100, for trading, on a local trading platform, foreign financial assets, in accordance with an exemplary embodiment of the present invention. The foreign financial assets, designated as 115, are denominated in a foreign currency. The financial assets 115 may be traded on an exchange (not illustrated) located in the foreign country, although such trading is not required by embodiments of the present invention. By providing for the foreign financial assets 115 to be traded in the foreign currency, the system 100 provides options to the investor in exposing himself to currency risk and asset-price risk in the foreign financial assets 115.

As illustrated in FIG. 1, the system 100 includes a foreign issuing entity 110 and a local trading platform 130. In the system 100, the foreign issuing entity 110 issues the foreign financial assets 115 directly onto the local trading platform 130. (It is to be understood that the system 100 may still include a regulatory body.) The local trading platform 130, located in the local country, provides a market for the trading of the foreign financial assets 115 priced in the currency of the foreign country. The financial assets 115 are listed at a price denominated in the foreign currency and are traded on the local trading platform 130 in the foreign currency. Settlement takes place in the foreign currency. As used herein, the term “trading platform” means an exchange, electronic communication network (ECN), dark pool, or any other trading system operated by a broker or dealer. Examples of an exchange include a stock exchange or a futures and options exchange. Thus, the foreign assets 115 may be stocks, futures, or options. It is to be understood, however, that the term “trading platform” is not limited to an exchange.

It is noted that the term “local,” as used herein, refers to placement relative to the country in which a trading platform, e.g., the local trading platform 130, is located. It does not necessarily refer to the country in which the investor resides (although this may be the most common case). Specifically, the term “local” is used to describe the currencies that are issued and used in the country where the trading platform is located. A currency issued by the country where the trading platform is located is “local” to the trading platform, and the trading platform is local to the currency (referred to herein as a “local currency”).

Further, it is noted that the term “foreign,” as used herein, also refers to placement relative to the country in which a trading platform, e.g., the local trading platform 130, is located. Specifically, the term “foreign” is used to describe the currencies that are issued and used in a country foreign to the one where the trading platform is located. A currency issued by a country foreign to the one in which the trading platform is located (referred to herein as a “foreign currency”) is “foreign” to the trading platform. As explained above, the currency issued and used in the country in which the trading platform is located is a “local currency.”

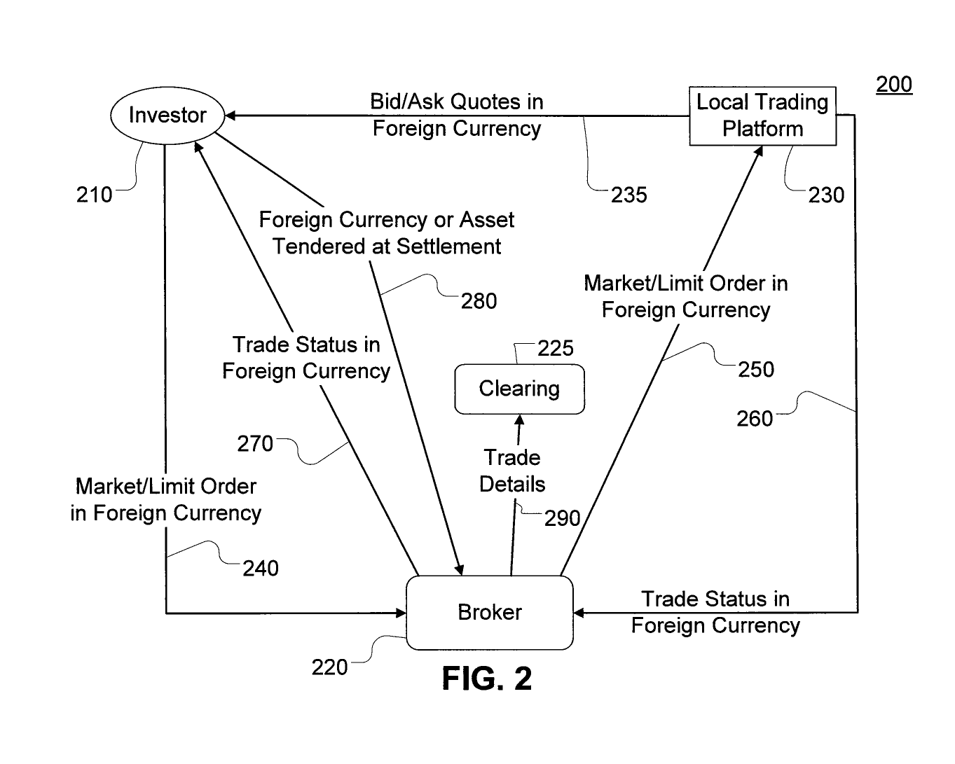

Referring now to FIG. 2, there is illustrated a trading system 200 in which an investor 210 buys and/or sells financial assets 115 (illustrated in FIG. 1) in a foreign currency on a local trading platform 230 via a broker 220, in accordance with an exemplary embodiment of the present invention. Thus, the local trading platform 230 is a trading platform for the trading of financial assets in a currency of a foreign country.

Embodiments in which the functions of the broker 220 and the local trading platform 230 are performed by the same entity are contemplated. In such embodiments, the broker 220 operates the local trading platform 230. Thus, although description below is made with reference to the broker 220 being separate from the local trading platform 230, it is to be understood that in some embodiments the broker 220 and the local trading platform 230 are the same entity.

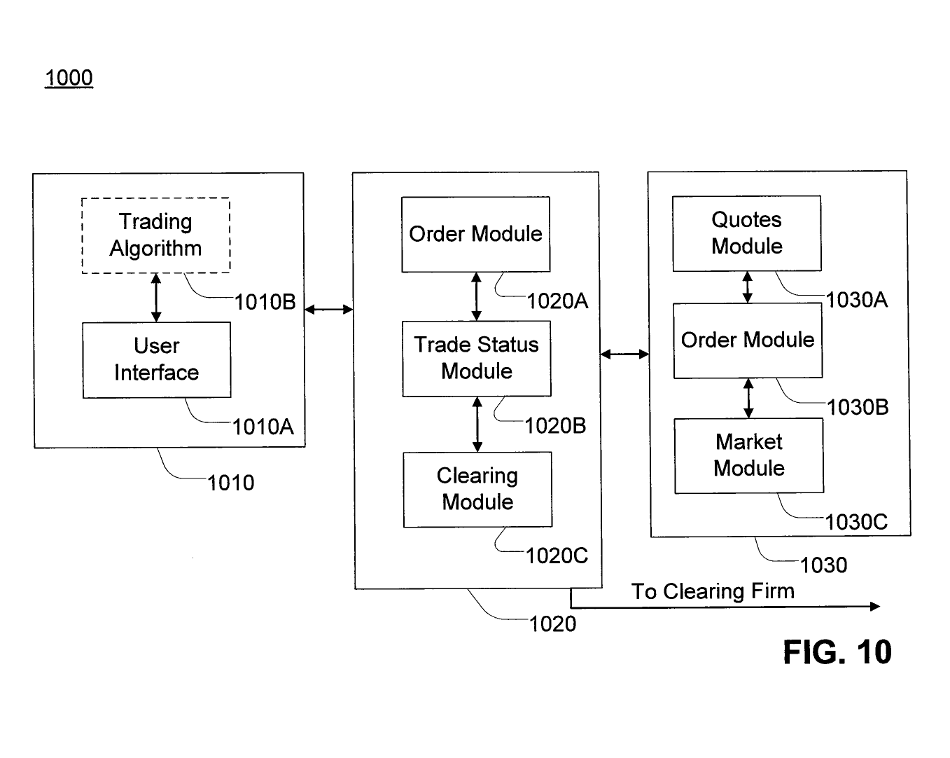

FIG. 2 illustrates the flow of information between the investor 210, the broker 220, and the local trading platform 230. In an exemplary embodiment, the information is transmitted in electronic packets that are transmitted over one or more computer networks between computer systems (see FIG. 10) operated, respectively, by the investor 210, the broker 220, and the local trading platform 230.

A plurality of financial assets 115 are listed and traded, i.e., offered, on the local trading platform 230 in a foreign currency. In one exemplary embodiment, the financial assets 115 are issued onto the local trading platform 230 using the method described above with respect to FIG. 1. Hence, they are issued onto the local trading platform 230 by a foreign issuing entity to be traded in a currency of the country in which the foreign issuing entity is located, i.e., a foreign currency. For example, the local trading platform 230 may be located in the United States, and the issuing entity may be located in Canada. The financial assets 115 traded on the local trading platform 230 in the United States may be priced and traded in Canadian dollars.

In another exemplary embodiment, the financial assets 115 are issued in one foreign country and traded in another foreign currency. An example of such an embodiment is one where a foreign issuing entity located in a foreign country B issues shares onto an trading platform in a local country A to be traded in a currency of another foreign country C. As a more specific example, the local trading platform 230 may be located in the United States, and the issuing entity may be located in the United Kingdom. The financial assets 115, issued by the issuing entity in the United Kingdom, are traded in the United States in Canadian dollars, in accordance with this embodiment of the present invention.

For purposes of discussion below, the financial assets 115 listed and traded on the local trading platform 230 are “foreign financial assets.” It is to be understood that the term “foreign financial assets” is not limited to financial assets issued by an issuing entity located in the country in which the foreign currency is legal tender. Rather, as used herein, the term “foreign financial assets” denotes any assets that are issued by any issuing entity and are traded in a currency foreign to the country where the local trading platform 230 is located. Further, it is to be understood that the term “foreign financial assets” is not limited to financial assets issued by an issuing entity foreign to the country in which the local trading platform 230 is located. Rather, it is contemplated that an issuing entity located in a local country may issue foreign financial assets onto a local trading platform.

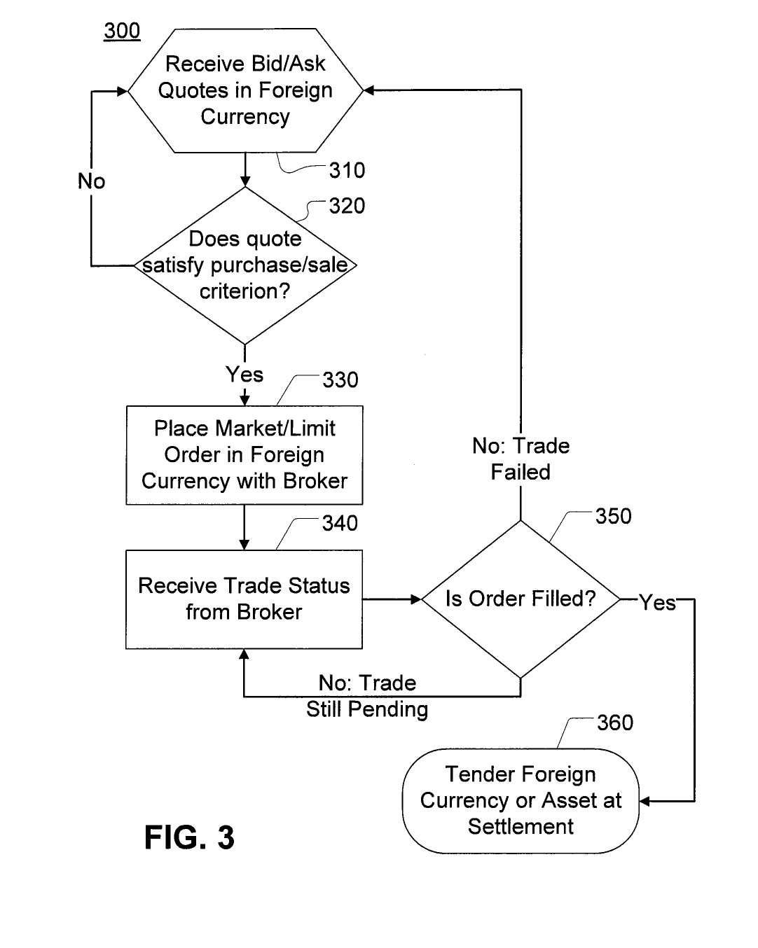

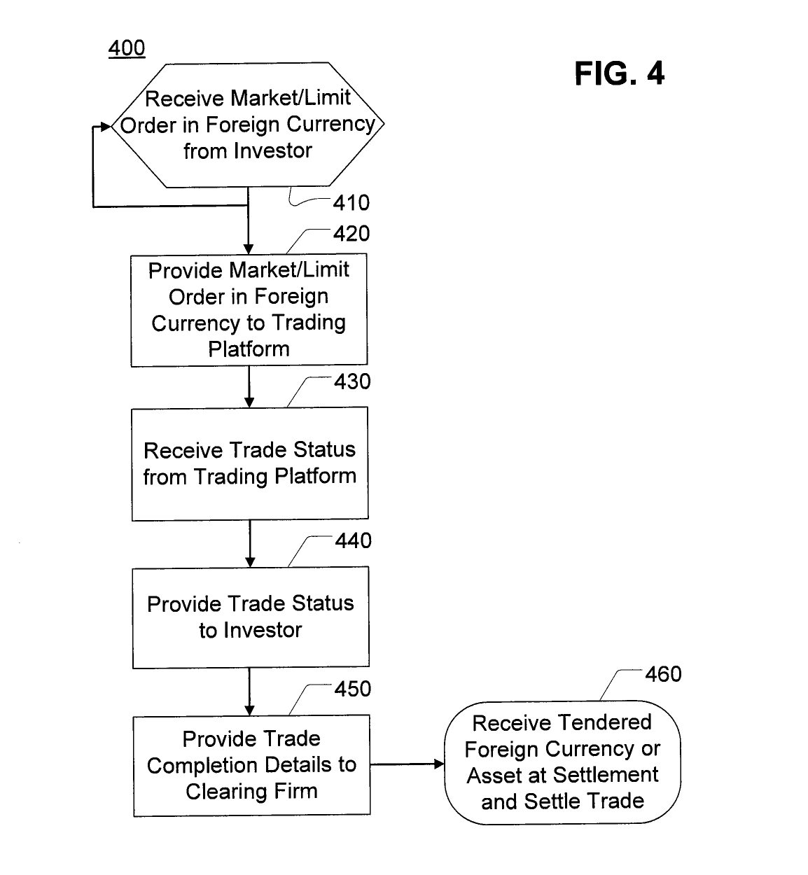

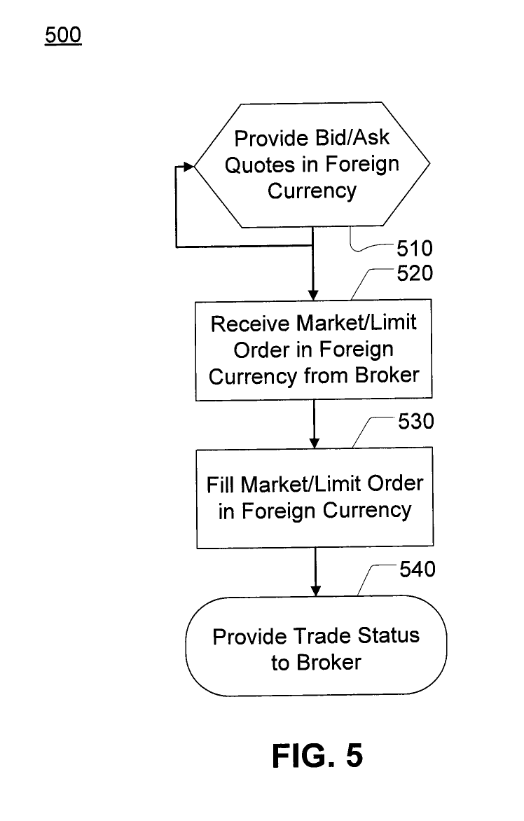

Illustrated in FIG. 3, FIG. 4, and FIG. 5 are, respectively, methods 300, 400, and 500 performed, respectively, by the investor 210, the broker 220, and the local trading platform 230 to facilitate and perform the buying and selling of foreign financial assets on the local trading platform 230. FIGS. 2-5 will now be described together because portions of methods 300, 400, and 500 are performed concurrently and make reference to elements illustrated in FIG. 2. One or more of the steps of each of the methods 300, 400, and 500 may be performed by a computer system operated, respectively, by the investor 210, the broker 220, and the local trading platform 230. Each computer system is programmed with software instructions to perform one or more steps of the respective methods 300, 400, and 500. Thus, although the description below refers to the investor 210, the broker 220, and the local trading platform 230 as performing certain steps, it is to be understood that the computer systems operated by the respective investor 210, broker 220, and local trading platform 230 may perform one or more of such steps, either automatically or at the direction of the investor 210, broker 220, and/or local trading platform 230.

A plurality of foreign financial assets 115 (illustrated in FIG. 1) are listed and traded on the local trading platform 230 in the foreign currency. The local trading platform 230 provides a stream of quotes 235, e.g., bid and ask quotes, for the foreign financial assets 115 priced in the foreign currency, Step 510. The local trading platform 230 may be configured to provide the quotes 235 on a continual basis during trading hours of the local trading platform 230.

The investor 210 receives the quotes 235, Step 310. It is to be understood that, although the system 200 illustrates that the investor 210 receives the quotes 235 directly from the local trading platform 230, it is contemplated that in other embodiments the investor 210 may receive such quotes from the broker 220 instead. In such alternative embodiments, the broker 220 receives the quotes 235 from the local trading platform 230 and passes them to the investor 210.

The investor 210 or a trading algorithm (described in more detail with respect to FIG. 10) implemented by the computer system of the investor 210 analyzes the quotes 235 to determine whether one or more of the quotes 235 satisfy one or more purchase or sale criteria, Step 320. If the one or more of the quotes 235 do not satisfy any purchase or sale criteria, processing proceeds at the Step 310, with the investor 210 continuing to receive the quotes 235 priced in the foreign currency. If the one or more of the quotes 235 satisfy the purchase or sale criteria, the investor 210 places an order 240 priced in the foreign currency, Step 330. For example, the investor 210 may place with the broker 220 (1) a market order 240 that specifies a market price for the purchase or sale of a financial asset in the foreign currency or (2) a limit order 240 that specifies an amount of the foreign currency for the purchase or sale of the financial asset in the Step 330, depending on the preferences of the investor 210. For purposes of brevity, “market order 240” and “limit order 240” are collectively referred to herein as an “order 240.” The context of “order 240” herein dictates whether “order 240” refers to a market order or a limit order.

The broker 220 receives the order 240, Step 410, and forwards it through to the local trading platform 230, Step 420, as an order 250. The local trading platform 230 receives the order 250, Step 520, and fills the order, Step 530, if possible. After receiving the order 250, the local trading platform 230 provides periodic indications 260 of the status of the order 250, Step 540. For example, the indications 260 are provided in a text stream and include tags and tag values that provide information on various aspects of the order 240. Examples of tags include the size of the order 240, the quantity of the order 240 filled or partially filled, the price of the fill, etc. If the trading platform is able to fill the order, the indications 260 inform the broker 220 of trade completion in the Step 540. If the trading platform 230 is unable to fill the order, the indications 260 inform the broker 220 that the trade has failed to be completed in the Step 540.

The broker 220 receives the indications 260 of the status of the order, Step 430, and forwards them to the investor 210 as indications 270 of trade status, Step 440. If the indications 260 indicate that the order is filled, the broker 220 forwards the indications 260 to a clearing firm 225 as trade completion details 290, Step 450. The clearing firm 225 clears the trade with the counterparty to the investor 210 in the trade based upon the trade completion detail 290 and those provided by the broker of the counterparty. For example, if the investor 210 purchases one or more foreign financial assets, the trade is cleared with the counterparty who sold the one or more foreign financial assets to the investor 210. Clearing is typically performed by the clearing firm 225 at the end of the day after the local trading platform 230 closes.

The investor 210 receives the indications 270 of trade status, Step 340. At Step 350, a determination is made regarding whether the order 240 is filled. If the order is filled, the investor 210 tenders 280 payment in the foreign currency or tenders 280 the financial asset at settlement, Step 360. In the case of a sale, the investor 210 tenders 280 the financial asset sold on the local trading platform 230 at settlement in the Step 360. In the case of a purchase, the investor 210 tenders 280 payment in the foreign currency for the financial asset purchased on the local trading platform 230 in the Step 360. The broker 210 receives the payment or the financial asset, Step 460, and settles the trade with the counterparty.

If the order is not filled because it is still pending, processing proceeds at the Step 340, and the investor 210 continues to receive the indications 270 of trade status. If the order is not filled because it has failed, processing proceeds at the Step 310, and the investor 210 continues to receive the quotes 235. It is to be understood that the investor 210 may still receive the quotes 235 while the order is still pending.

The investor 210, the broker 220, the trading platform 230, and the clearing firm 225 may each be located in the same country or in one or more different countries. For practical purposes, certain features of the exemplary trading system 200 of FIG. 2 may reside in a particular country due to laws and/or regulations relating to the trade of the selected financial asset in these countries or laws relating to the currency of the countries. For example, some trading platforms require the entity (or entities) performing the brokerage, clearing, and/or custodial functions to be registered with the trading platform. Such entities are often subject to licensing by the country in which the trading platform resides as well and are typically required to hold citizenship (as an individual or a corporate entity) within the country. Thus, the entity (or entities) performing the functions of the broker 220, the clearing firm 225, and/or custodial functions in the trading system 200 may usually be located in the same country as the trading platform 230.

When purchasing assets priced and traded in a foreign currency, an investor, e.g., the investor 210, may need to acquire some or all of the foreign currency needed to settle the trade. Thus, the investor may need to purchase foreign currency using local currency in the FX market at the going exchange rate before or at settlement so that he is able to tender payment in the foreign currency at settlement. Further, the investor may not want to wait until settlement to make such conversion as he may expect to receive a better conversion rate at some time before settlement. When selling assets priced and traded in a foreign currency, an investor, e.g., the investor 210, may not want to wait until settlement to convert foreign currency received to local currency. Thus, the investor may want to purchase local currency in the FX market at the going exchange rate before settlement.

The fact that there is often a period of time between the trade, where the price of the financial asset in the foreign currency is locked in, and settlement, where the foreign currency must be delivered, complicates matters. If the local currency appreciates against the foreign currency during this period, the investor profits by waiting to exchange the local currency for foreign currency when buying the financial assets, but loses when selling. If the local currency depreciates against the foreign currency, the investor loses by waiting to exchange the local currency for foreign currency when buying, but gains when selling. In some cases, currency swings during the time between trade and settlement can be more significant to the investor's total return than the actual appreciation or depreciation of the particular financial assets.

For example, in the case of trades placed on a local trading platform, suppose settlement in the foreign currency occurs three business days after the trade is made. Because the currency conversion rate for converting between the local currency and the foreign currency may fluctuate between trade and settlement, the effective price of the financial asset in the local currency may fluctuate between when the trade is made and when the trade is settled, even though the actual price, denominated in the foreign currency of the traded financial asset, was locked in at the trade.

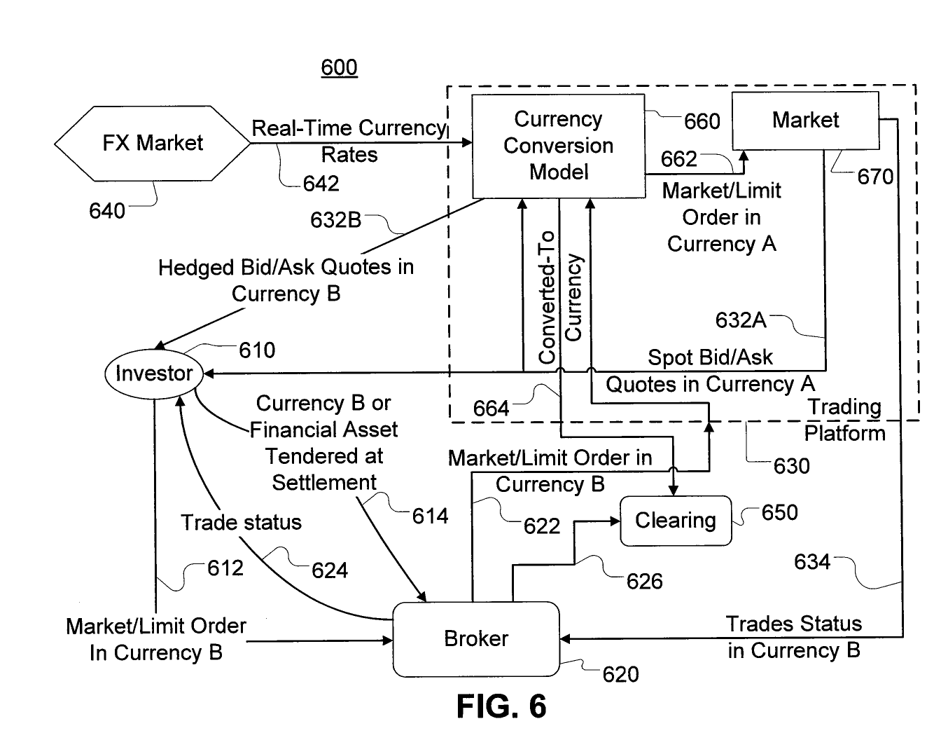

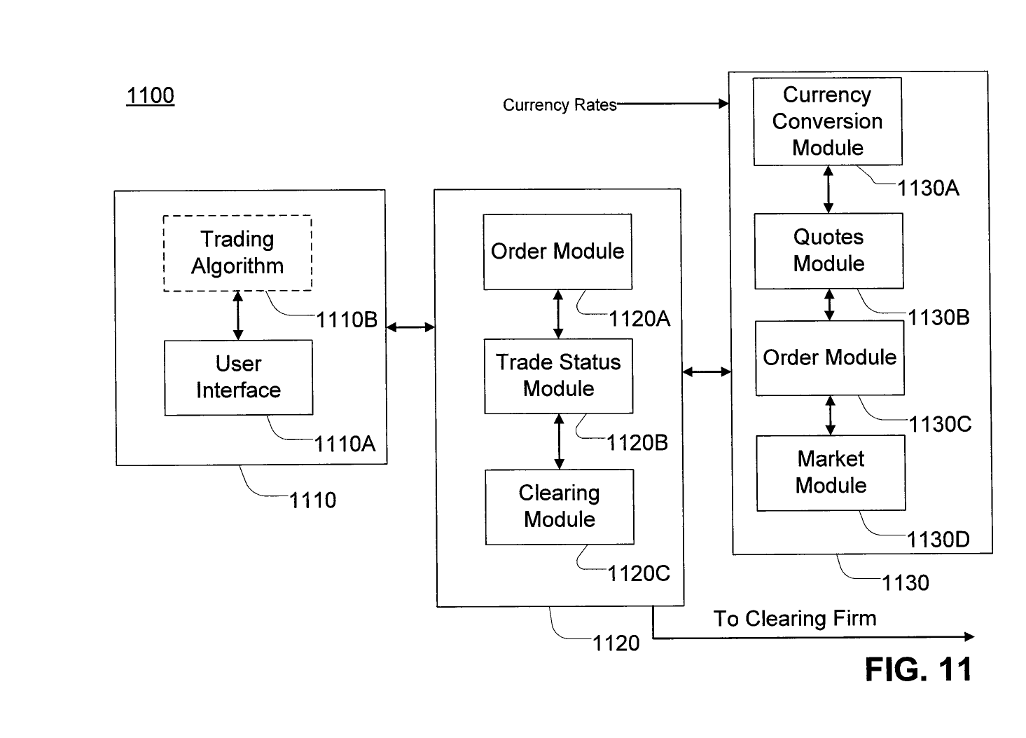

Referring now to FIG. 6, there is illustrated a trading system 600 in which an investor 610 buys and/or sells financial assets on an trading platform 630 via a broker 620, in accordance with an exemplary embodiment of the present invention. The trading platform 630 is a trading platform for the trading of financial assets in any currency. FIG. 6 illustrates the flow of information between the investor 610, the broker 620, and the trading platform 630. In an exemplary embodiment, the information is transmitted in electronic packets that are transmitted over one or more computer networks between computer systems (see FIG. 11) operated, respectively, by the investor 610, the broker 620, and the trading platform 630.

Embodiments in which the functions of the broker 620 and the local trading platform 630 are performed by the same entity are contemplated. In such embodiments, the broker 620 operates the trading platform 630. Thus, although description below is made with reference to the broker 620 being separate from the local trading platform 630, it is to be understood that in some embodiments the broker 620 and the local trading platform 630 are the same entity.

A plurality of financial assets are listed and traded on the trading platform 630, specifically in a market 670 of the trading platform 630, in a currency A (also referred to herein as a “first currency”). In one exemplary embodiment, the financial assets are issued onto the trading platform 630 using the method described above with respect to FIG. 1. Hence, they are issued onto the trading platform 630 by an issuing entity to be traded in the market 670 in a currency (currency A) of the country in which the issuing entity is located. For example, the market 670 may be located in the United States, and the issuing entity may be located in Canada. The financial assets traded on the market 670 in the United States may be priced and traded in Canadian dollars. Thus, currency A is Canadian dollars. As will be explained below, however, currency A in the trading system 600 is not limited to being legal tender in a country foreign to the one in which the market 670 is located. In fact, for example, currency A may be U.S. dollars and the market 670 and the issuing entity may be located in the United States.

In another exemplary embodiment, the financial assets, although traded in currency A, are not issued by an entity located in the country where currency A is legal tender. Instead, such financial assets are issued by an entity in a country other than the country where currency A is legal tender. Thus, an issuing entity located in a country outside of the one where currency A is legal tender issues shares onto the trading platform 630 to be traded in currency A. As an example, the market 670 may be located in the United States, and the issuing entity may be located in the United Kingdom. The financial assets issued by the issuing entity for trade on the trading platform 630 may be priced and traded in Canadian dollars. Thus, currency A is Canadian dollars. As another example, the trading platform 630 and the issuing entity may be located in the United States, and the financial assets may be priced and traded in British pounds.

Orders to buy and sell financial assets that are traded on the trading platform 630 in currency A are placed in a currency B (also referred to herein as a “second currency”). All combinations of currency A and currency B are contemplated. Where currency A and currency B are both the same currency and are both a foreign currency, the trading system 200 may be used as no currency conversion model (described below) is required. When currency A and currency B are both the same currency and are both a local currency (local to the trading platform 630), a conventional trading system may be used. Where currency A is not the same as currency B, the trading system 600 is contemplated to be used for any combination of currency A and currency B. An example is where currency A is Canadian dollars, currency B is U.S. dollars, and the trading platform 630 is located in the United States. Another example is where currency A is U.S. dollars, currency B is Canadian dollars, and the trading platform 630 is located in the United States. Yet another example is where currency A is Euros, currency B is Japanese Yen, and the trading platform 630 is located in the United States.

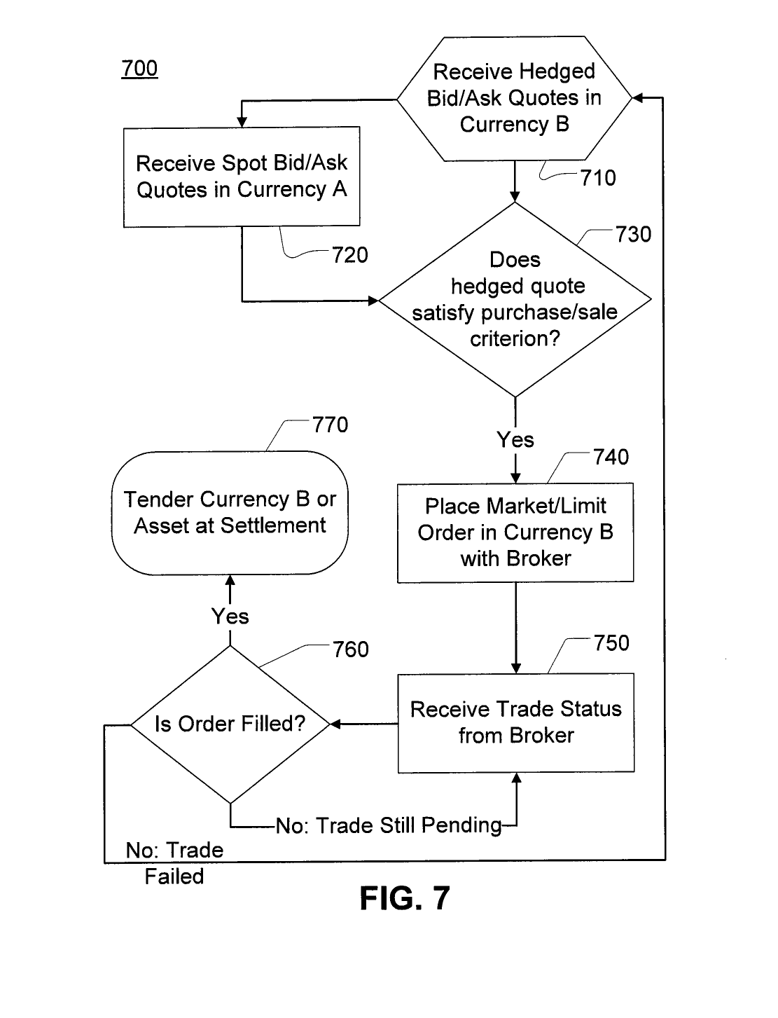

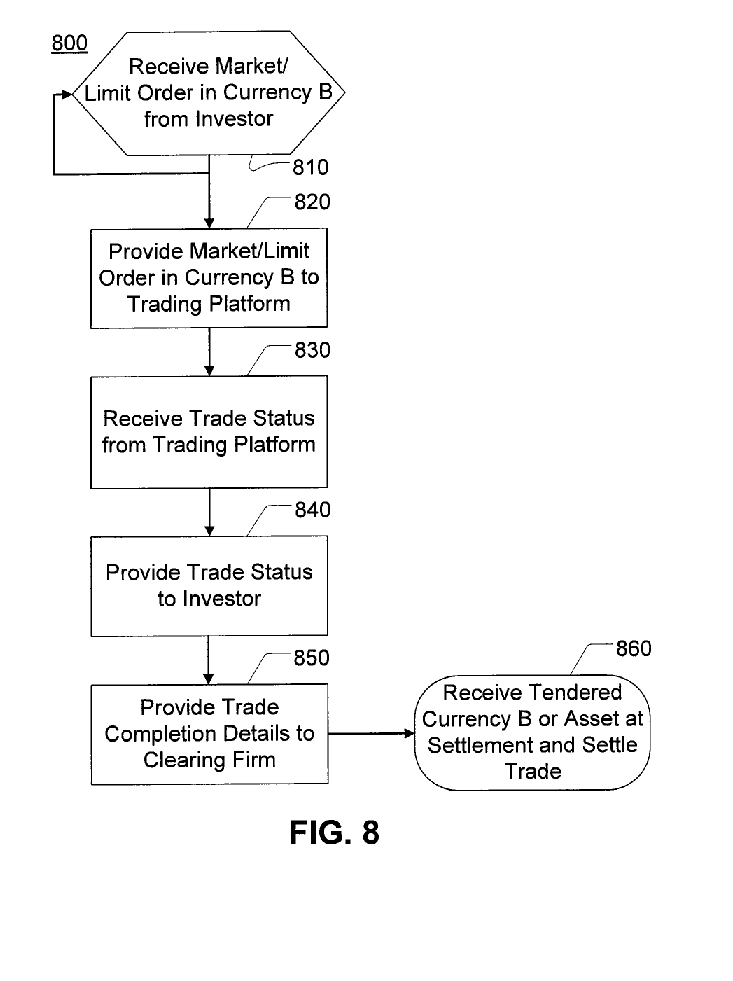

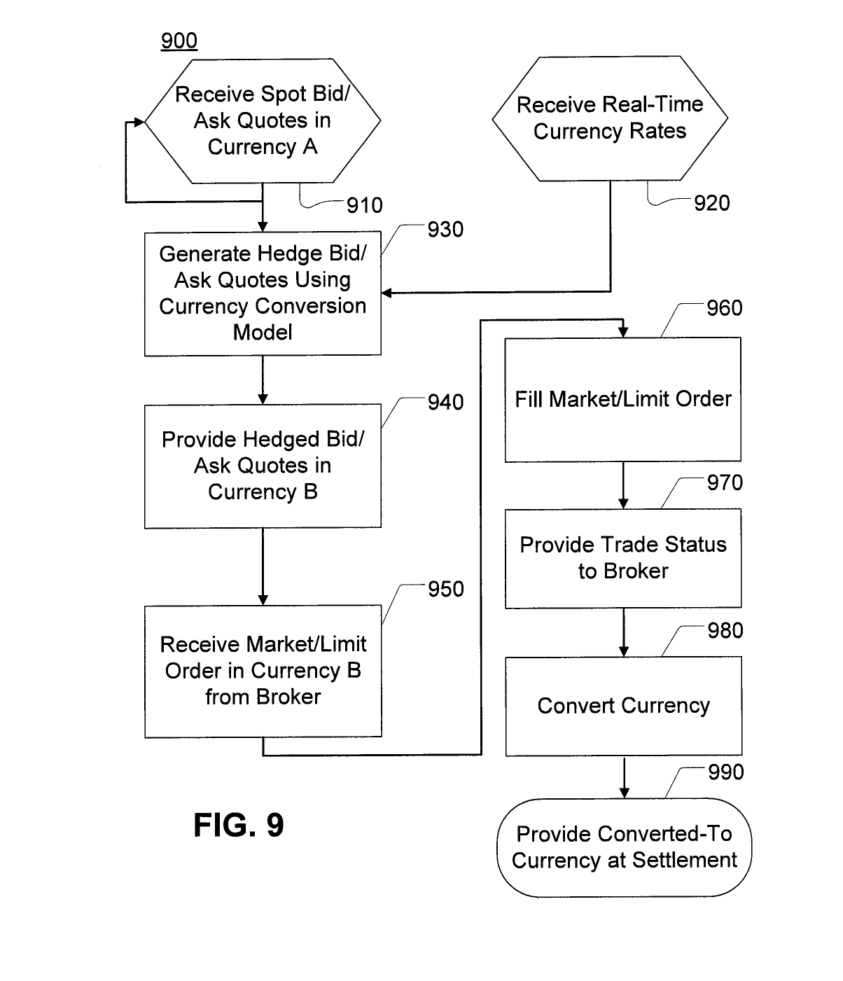

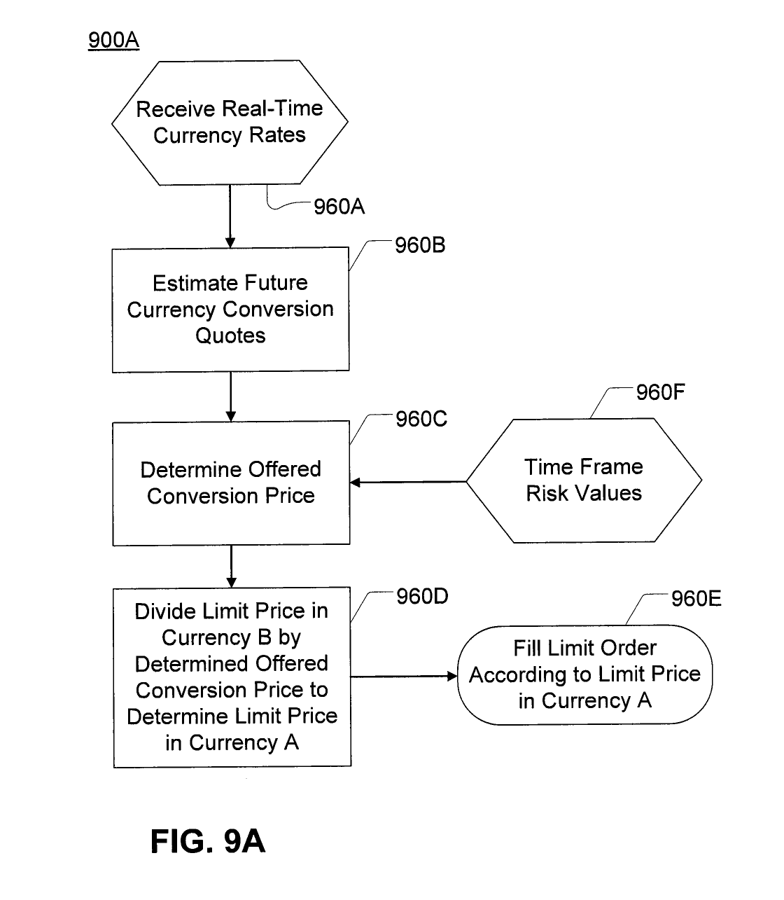

Illustrated in FIG. 7, FIG. 8, and FIG. 9 are, respectively, methods 700, 800, and 900 performed, respectively, by the investor 610, the broker 620, and the trading platform 630 to facilitate and perform the buying and selling of financial assets on the trading platform 630. FIGS. 6-9 will now be described together because portions of methods 700, 800, and 900 are performed concurrently and make reference to elements illustrated in FIG. 6. One or more of the steps of each of the methods 700, 800, and 900 may be performed by a computer system operated, respectively, by the investor 610, the broker 620, and the trading platform 630. Each computer system is programmed with software instructions to perform one or more steps of the respective methods 700, 800, and 900. Thus, although the description below refers to the investor 610, the broker 620, and the trading platform 630 as performing certain steps, it is to be understood that the computer systems operated by the respective investor 610, broker 620, and trading platform 630 may perform one or more of such steps, either automatically or at the direction of the investor 610, broker 620, and/or trading platform 630.

A plurality of financial assets are listed and traded on the trading platform 630. The trading platform 630 includes a currency conversion model 660 and a market 670 where the plurality of financial assets are traded in currency A. The trading platform 630 provides a stream of spot quotes 632A, e.g., bid and ask quotes, in currency A and a stream of hedged quotes 632B, e.g., bid and ask quotes, in currency B. The trading platform 630 is configured to provide the spot quotes 632A and the hedged quotes 632B on a continual basis during trading hours of the market 670. It is to be understood (and is clarified below) that the investor 610 does not provide payment denominated in currency A when buying the financial assets and does not receive payment denominated in currency A when selling the financial assets. Rather, the investor 670 performs transactions in currency B.

The market 670 provides the spot quotes 632A denominated in currency A to the investor 610 and to the currency conversion model 660 as a substantially real-time series of quotes. The currency conversion model 660 receives the spot quotes 632A, Step 910. The currency conversion model 660 also receives at least one substantially real-time series of currency conversion quotes 642 for converting between currency A and currency B, Step 920, from an FX market 640, The FX market 640 may comprise a network of various banks and/or financial institutions that provide a market for trading currencies, depending on which currencies are to be exchanged.

The currency conversion quotes 642 are applied to the currency conversion model 660, Step 930. The currency conversion model 660 may be any one of a number of currency conversion models adapted to estimate future currency conversion quotes (not illustrated), such as the currency conversion models described in U.S. Pat. No. 7,542,939, issued Jun. 2, 2009 and U.S. patent application Ser. No. 11/950,081, filed Dec. 4, 2007, both of which naming a common co-inventor and assignee of the present invention, and incorporated fully herein by reference. The estimated future currency conversion quotes desirably include an expected time or a timeframe for the estimated quotes, i.e., when the estimated future currency conversion is to take place. The currency conversion model 660 may further estimate risk values associated with the future currency conversion quotes.

In an exemplary embodiment, the currency conversion model 660 repeatedly or serially estimates the future currency conversion quotes to generate a stream (or series) of estimated future currency quotes. As the model 660 estimates such quotes it updates the expected time or timeframe for the estimated quotes, i.e., when the estimated future currency conversion is to take place.

An offered conversion price for converting a specified amount of the currency B to currency A or vice versa within a settlement time window is determined using the current or estimated future currency conversion quotes. The settlement time window is the time period between the current time when the offered conversion price is being determined and the settlement time for the financial asset. Thus, the settlement time window extends for the settlement period of the financial asset, typically two or three business days.

In the exemplary embodiment in which the currency conversion model 660 repeatedly estimates the future currency conversion quotes, the offered conversion price is repeatedly or serially calculated to determine a series of offered conversion prices. It is to be understood, therefore, that as the series of offered conversion prices is calculated, the settlement time window is adjusted to account for the progression of time. Thus, a series of settlement time windows is determined.

In one exemplary embodiment, the currency conversion model 660 includes an algorithm for determining the offered conversion price. The algorithm may include parameters for the current or estimated future currency conversion quotes. The algorithm may also include parameters for risk values associated with the future currency conversion quotes, if the currency conversion model 660 is adapted to estimate risk values associated with the future currency conversion quotes. In another exemplary embodiment, a computer module of the trading platform 630 outside of the currency conversion model 660 includes such an algorithm.

The algorithm desirably determines a best estimated conversion price within the settlement time window and an associated trade fee. The trade fee accounts for risk being taken by the trading platform 630 and the period of time that the currency would be tied up between the estimated trade time and the settlement, as well as a fee for the currency conversion services. The trade fee may also take into account the nature of the investor 610 (e.g., a large, important investor institution versus a small investor) and/or the size of the trade to be placed. As used herein, the terms “trader, “investor” and “customer” are considered equivalent terms. The best estimated conversion price is added to the associated trade fee to obtain the offered conversion price. It is noted that in an exemplary embodiment the best estimated conversion price is the conversion price that leads to the lowest offered conversion price; it is not necessarily the lowest estimated conversion price.

The current quote of the substantially real-time series of quotes 632A for the assets is multiplied by the offered conversion price to determine a hedged quote for the asset in currency B, Step 930. The trading platform 630 outputs the hedged quote, Step 940.

In an exemplary embodiment, the currency conversion model 660 multiplies the current quote of the substantially real-time series of quotes 632A by the offered conversion price to determine the hedged quote for the financial asset in currency B. It is contemplated, however, that such multiplication may be performed by a computer module separate from the currency conversion model 660. For example, such multiplication may be performed by a hedged-quote calculation module in the trading platform 630 that receives the current quote of the substantially real-time series of quotes 632A from the market 670 and the offered conversion price from the currency conversion model 660 and multiplies them together to determine the current quote of the substantially real-time series of hedged quotes 632B for the asset in currency B.

The trading platform 630 generates the stream of hedged quotes 632B specified in currency B by multiplying a continually updated offered conversion price by successive ones of the spot quotes 632A specified in currency A. More specifically, the currency conversion model 660 or the hedged-quote calculation module successively multiplies a respective one of the series of offered conversion prices by a respective one of the spot quotes 632A specified in currency A to generate the stream of hedged quotes 632B.

The investor 610 receives the hedged quotes 632B denominated in currency B, Step 710, and the spot quote 632A denominated in currency A, Step 720. The hedged quotes 632B, priced in currency B, may be displayed on the computer system operated by the investor 610 so that the investor 610 can determine if he wishes to place an order, Step 730. The spot quotes 632A, priced in currency A, may also be displayed on the computer system to assist the investor 610 in his determination. In an exemplary embodiment, the determination in the Step 730 is made by a trading algorithm (described in more detail below) operating on the computer system of the investor 610.

The hedged quotes 632B are quotes in currency B that the investor 610 may use without further calculation or uncertainty. Accordingly, risk to the investor 610 is subsumed into the trade fee associated with the best estimated conversion price (used to generate the hedged quotes 632B) and, therefore, into the hedged quotes 632B.

Although the system 600 illustrates that the investor 610 receives the spot quotes 632A and the hedged quote 632B directly from the trading platform 630, it is to be contemplated that in other embodiments the investor 610 may receive such quotes from the broker 620 instead. In such alternative embodiments, the broker 620 receives the quotes from the trading platform 630 and passes them to the investor 610. It is further contemplated that the investor 610 may receive only the hedged quotes 632B and not the spot quotes 632A.

The investor 610 may also wish to see spot quotes, e.g., bid and ask quotes, for the financial asset in currency B displayed alongside the hedged quotes 632B for the financial asset in currency B. Such spot quotes may be calculated by selecting a current spot currency conversion quote from the substantially real-time series of currency conversion quotes 642, the currency conversion quote being a best quote for converting between currency A and currency B at approximately the current time. The selected spot currency conversion quote is then multiplied by a current quote of the substantially real-time series of quotes 632A to determine a current spot quote (not illustrated in FIG. 6) for the financial asset in currency B. The current spot currency conversion quote is successively selected and multiplied by successive ones of the substantially real-time series of quotes 632A to determine a substantially real-time series of spot quotes for the financial asset in currency B. The spot quotes for the financial asset in currency B may be supplied to the investor 610.

The investor 610 or the automatic trading algorithm of the investor 610 analyzes the hedged quotes 632B to determine whether one or more of the hedged quotes 632B satisfy one or more purchase or sale criteria, Step 730. If the one or more of the hedged quotes 632B do not satisfy the purchase or sale criteria, the method 700 loops back to the Step 710, and the investor 610 continues to receive the hedged quotes 632B priced in currency B. If the one or more of the hedged quotes 632B do satisfy the purchase or sale criteria, the investor 610 places an order 612 priced in currency B, Step 740. Specifically, the investor 610 may place (1) a market order 612 that stipulates that the trade is to be completed at a market price in currency B or (2) a limit order 612 that specifies a limit price of currency B for the trade in the Step 740. The investor 610 places the order with the broker 620.

The broker 620 receives the order 612, Step 810, and passes it through to the trading platform 630, Step 820, as an order 622. In accordance with the order 612, the order 622 may be a market order specifying that a trade for one or more financial assets be completed at the best market price (priced in currency B), or the order 622 may be a limit order specifying that a trade for one or more financial assets be completed within a specified limit price denominated in currency B. The trading platform 630 receives the order 622, Step 950, and fills the order if possible, Step 960.

To fill the order, the trading platform 630 identifies a counterparty to the order 622 of the investor 610 in the Step 960. Specifically, the trading platform 630 matches party and counterparty in currency A. If the order 612 (order 622) of the investor 610 in currency A matches a counterparty's order in currency A (either made in currency A or converted to currency A), the trading platform 630 completes the trade in the Step 960, i.e., it fills the order, and indicates that that trade is filled. If part of the order 612 (order 622) of the investor 610 matches a counterparty's order (either made in currency A or converted to currency A, as described below), the trading platform 630 partially completes the trade in the Step 960, i.e., it partially fills the order, and indicates that the trade is partially filled, if the order 622 allows partial filling. It then attempts to fill the rest of the order 612 (order 622).

In the case of the order 622 being a market order, the trading platform 630 identifies the market price for filling part or all of the order 622 in currency A, as the market 670 matches buyers and sellers in currency A. After the trade is filled, the trading platform 630 determines the trade price in currency B, i.e., the price to the investor 610 in currency B. The trade price to the investor 610 in currency B is the trade price in currency A multiplied by the offered conversion price calculated by the currency conversion module 660 at the time of the trade. The trade price in currency B is the amount the investor 610 should tender at settlement, in the case of the order 622 being a purchase order, or the amount the investor 610 expects to receive at settlement, in the case of the order 622 being a sell order. It is to be understood that trade price in currency B is not necessarily equal to the hedged quote 632B reported by the trading platform 630 at the time the investor 610 places the order 612 (order 622). Rather, the hedged quotes 632B provide the investor 610 with a sense of the market price of the financial assets priced in currency B. The actual trade price in currency B may differ due to market movement after the hedge quotes 632B are provided. Embodiments of the trading system 600 in which the trade price in currency B equals the current hedged quote 632B are contemplated. In such an embodiment, the investor 610 is assured that his order 612 will be filled at the most current hedged quote 632B.

In the case of the order 612 (order 622) being a limit order, the trading platform 630 executes a method 900A illustrated in FIG. 9A, in accordance with an exemplary embodiment of the present invention. The method 900A specifies exemplary sub-steps performed by the trading platform 630 in the Step 960.

In the method 900A, in addition to the trading platform 630 receiving the limit order 622, the trading platform 630 also receives the substantially real-time series of currency conversion quotes 642, Step 960A. The trading platform 630 applies the quotes 642 to the currency conversion module 660 to estimate future currency conversion quotes using similar techniques to those discussed above, Step 960B. An offered conversion price for converting a specified amount of currency B to currency A or vice versa within a settlement time window is determined using the current or estimated future currency conversion quotes, Step 960C. The limit price in the limit order 622 in currency B is divided by the offered conversion price to determine a limit price of the limit order 622 in currency A, Step 960D. The trading platform 630 then attempts to fill the limit order 622 at the limit price in currency A or better, Step 960E.

In the case of the order 622 being a limit order, the timeframe for which the order 622 remains open may vary greatly from other limit orders and may remain open for long periods of time compared to the settlement time window. In an exemplary embodiment, the algorithm employed by the currency conversion model 660 determines the best estimated conversion price over a time frame equal to the time specified in the limit order plus the settlement time window. The best estimated conversion price is added to the trade fee to arrive at the offered conversion price. The time frame and other parameters, such as risk values, are specified in a Step 960F.

The limit price in the order 622 priced in currency B is a price that removes all currency conversion risk between trade and settlement from the investor 610. When placing the order 622, the investor 610 is assured that he will pay a price no worse than the limit price specified in currency B in the limit order at settlement. Thus, from the standpoint of the investor 610, the limit order 622 provides no currency conversion risk during the settlement timeframe.

Continuing in FIG. 9, after receiving the order 622, the trading platform 630 provides indications 634 over time of trade status, Step 970. Such indications include that the order 622 is received, has been partially filled, has been entirely filled, etc. For example, the indications 634 are provided in a text stream and include tags and tag values that provide information on various aspects of the order 622. Examples of tags include the size of the order 622, the quantity of the order 622 filled or partially filled, the price of the fill, etc. If the trading platform 630 is able to fill the order, the indication 634 informs the broker 620 of trade completion in the Step 970. If the trading platform 630 is unable to completely fill the order, the indication 634 informs the broker 620 of trade failure in the Step 970.

The broker 620 receives the indications 634 of the status of the order, Step 830, and forwards them to the investor 610 as indications 624 of trade status, Step 840. If the indications 634 indicate that the order is filled, the broker 620 forwards the indications 634 to a clearing firm 650 as trade completion details 626, Step 850. The clearing firm 650 clears the trade with the counterparty to the investor 610 in the trade based upon the trade completion detail 626 and those provided by the broker of the counterparty. For example, if the investor 610 purchases one or more financial assets, the trade is cleared with the counterparty who sold the one or more financial assets to the investor 610. Clearing is typically performed by the clearing firm 650 at the end of the day after the trading platform 630 closes.

The investor 610 receives the indications 624 of trade status, Step 750. In Step 760, a determination of whether the order 612 was filled is made. If the order 612 was filled, the investor 610 tenders 614 payment in currency B or tenders 614 the financial asset at settlement, Step 770. In the case of a sale, the investor 610 tenders 614 the financial asset sold on the trading platform 630 at settlement in the Step 770. In the case of a purchase, the investor 610 tenders 614 payment in currency B for the financial asset purchased on the trading platform 630 in the Step 770. The broker 610 receives the payment or the financial asset, Step 860, and settles the trade with the counterparty.

If the order is not filled because it is still pending, processing proceeds at the Step 750, and the investor 610 continues to receive the indications 624 of trade status. If the order is not filled because it has failed, processing proceeds at the Step 710, and the investor 610 continues to receive the hedged quotes 632B. It is to be understood that the investor 610 may still receive the hedged quotes 632B while the order is still pending.

Between trade and settlement, the trading platform 630 may convert an amount of currency B to a certain amount of currency A 664, or vice versa, as needed for the trade, Step 980. The trading platform 630 makes the conversion at the expected time that was provided for in the offered conversion price at the time of the trade (in the case of the order 612 being a market order) or when the order was placed (in the case of the order 612 being a limit order). The trading platform 630 provides either the currency B 664 to the investor 610 or the converted-to currency A 664 to the counterparty at settlement, Step 990, depending on whether the investor 610 purchased or sold the financial assets. At settlement, the traded financial assets are exchanged between the investor 610 and the counterparty. In an exemplary embodiment, the trading platform 630 maintains a pool of currency from which it draws to perform such conversion.

For example, in the case that the investor 610 is purchasing financial assets, the investor 610 purchases such assets in currency B and provides currency B at settlement to the trading platform 630. Because the purchase in currency B is hedged by the trading platform 630 against currency A and the market 670 establishes a counterparty in the trade in currency A, the trading platform 630 converts an amount of currency B to currency A at the expected time that was provided for in the hedged quotes 632B to provide an amount of currency A required to settle with the counterparty. At settlement in the Step 990, the trading platform 630 provides the converted-to currency A to the counterparty; the investor 610 provides the currency B to the trading platform 630; and the counterparty provides the financial assets to the investor 610. The trade is thereby settled. It is to be understood that settlement may be conducted via an intermediary.

In the case that the investor 610 is selling financial assets, the investor 610 sells such assets in currency B and, therefore, expects to receive currency B at settlement. Because the sale in currency B is hedged by the trading platform 630 against currency A and the market 670 establishes a counterparty in the trade in currency A, the trading platform 630 converts an amount of currency A to currency B needed for settlement at the expected time that was provided for in the hedged quotes 632B. At settlement in the Step 990, the trading platform 630 provides the converted-to currency B to the investor 610; the investor 610 provides the financial assets to the counterparty; and the counterparty provides the currency A to the trading platform 630. The trade is thereby settled. It is to be understood that settlement may be conducted via an intermediary.

It is noted that it may be desirable by the trading platform 630 to purchase currency B by selling currency A or to sell currency B to purchase currency A (depending on whether the investor 610 is, respectively, selling or buying the financial assets) in several partial portions to somewhat mitigate the risk of waiting for a particular low conversion price, without completely missing such potential opportunities. If such a strategy is desired, the set of risk criteria may include several subsets of partial purchase or sale risk criteria. Each subset of partial purchase risk criteria is associated with a partial purchase of the predetermined amount of the currency A. Each subset of partial sale risk criteria is associated with a partial sale of the predetermined amount of the currency A. These subsets of risk criteria may vary to account for the portion of the overall amount of currency A that has already been purchased or sold.

The subsets of partial purchase or sale risk criteria are selected in order and an expected transaction time for a selected subset is determined and updated until that corresponding portion of the predetermined amount of the currency A is purchased or sold. Once a subset is selected, the selected subset of partial purchase or sale risk criteria is removed from the set of risk criteria and a next subset is selected and a new expected transaction time is determined. This process continues until the entire predetermined amount of the currency A has been purchased or sold.

Although the system 600 is described with respect to a trade between an investor 610 buying or selling in currency B and a counterparty to the trade respectively selling or buying in currency A, it is to be understood that the counterparty is not limited to transacting in the currency in which parties and counterparties are matched in the market 670, i.e., currency A. Specifically, as investor 610 transacts in currency B, so too can the counterparty transact in a currency other than currency A, e.g., a third currency, such as a currency C. Such currency may be essentially any currency. In such an embodiment, the currency conversion model 660 calculates hedged quotes in currency C, outputs such quotes, and handles orders priced in currency C analogously to how it handles orders priced in currency B.

Where currency A and currency C are both the same currency and are both a foreign currency, the trading system 200 may be used as no currency conversion model is required. When currency A and currency C are both a local currency (local to the trading platform 630), a conventional trading system may be used. Thus, the trading system 600 is contemplated to be used for any combination of currency A and currency C, where currency A is not the same as currency C.

The investor 610, the broker 620, the trading platform 630, and the clearing firm 650 may each be located in the same country or one or more different countries. For practical purposes, certain features of the exemplary trading system 600 of FIG. 6 may reside in a particular country due to laws and/or regulations relating to the trade of the selected financial asset in these countries or laws relating to the currency of the countries. For example, many exchanges require the entity (or entities) performing the brokerage, clearing, and/or custodial functions to be registered with the exchange. Such entities are often subject to licensing by the country in which the exchange resides as well and are typically required to hold citizenship (as an individual or a corporate entity) within the country. Thus, the entity (or entities) performing the functions of the broker 620, the clearing firm 650, and/or custodial functions in the trading system 600 of the present invention may usually be located in the same country as the trading platform 630.

The financial modeling and calculations involved in various exemplary embodiments of the present invention may be carried out through the use of a general-purpose computer system programmed with software instructions to perform the steps of the exemplary methods described above. Exemplary general-purpose computer systems may include personal computers, work stations, distributed processing computer networks, and parallel processing computer systems. Parallel or distributed processing may be desirable for substantially real-time applications involving the substantially concurrent prediction of future quotes for a plurality of currencies. Dedicated special-purpose computing systems may also be designed for performing exemplary methods of the present invention as well.

Referring now to FIG. 10, there is illustrated a functional block diagram 1000 for the system 200, in accordance with an exemplary embodiment of the present invention. The functional block diagram 1000 includes a user interface 1010A which operates on a computer system 1010 of the investor 210 in the system 200. It is through this user interface 1010A that the investor 210 (or the computer system 1010 of the investor 210) receives the quotes 235, places the order 240, receives the trade status/completion 270, and tenders the currency 280 or the asset 280 at settlement. In an exemplary embodiment, the computer system 1010 includes a trading algorithm 10106 which is programmed into the computer system 1010 to perform one or more of the steps of the method 300. Thus, the computer system 1010 is programmed within the trading algorithm 10106 to perform one or more of the following: receive the quotes 235 (Step 310); determine whether to place the order 240 (Step 320); place the order 240 (Step 330); receive the trade status/completions 270 (Step 340); determine whether the order 240 is filled (Step 350); and tender the currency 280 or the asset 280 at settlement (Step 360). It is to be understood that the trading algorithm 10108 may be an automatic trading algorithm that is programmed into the computer system 1010 to perform the decision making performed in the Step 320 and the order placing performed in the Step 330 of the method 300 without intervention by the investor 210. Alternatively, the decision making performed in the Step 320 may be performed at the direction of the investor 210.

The functional block diagram 1000 also includes several functional blocks that operate on a computer system 1020 of the broker 220 in the system 200. Specifically, the computer system 1020 includes an order module 1020A, a trade status module 1020B, and a clearing module 1020C, which are programmed to perform respective steps of the method 400. The order module 1020A receives the order 240 from the computer system 1010 of the investor 210 (Step 410) and forwards it to the local trading platform 230 as the order 250 (Step 420). The trade status module 1020B receives the trade status 260 from the local trading platform 230 (Step 430) and forwards it to the computer system 1010 of the investor 210 as the trade status 270 (Step 440). The clearing module 1020C receives the trade status 260 and forwards it to the clearing firm 225 as the trade completion details 290 if the trade is complete (Step 450). The trade status module 1020B also receives the tendered asset 280 or the currency 280 from the investor 210 and settles the trade (Step 460). The modules 1020A-C are performed by the computer system 1020 which is programmed with software instructions or programmed in special-purpose hardware to perform the features of the modules 1020A-C.

Finally, the functional block diagram 1000 also includes several functional blocks that operate on a computer system 1030 of the trading platform 230 in the system 200. Specifically, the computer system 1030 includes a quotes module 1030A, an order module 1030B, and a market module 1030C, which are programmed to perform respective steps of the method 500. The quotes module 1030A provides the quotes 235, which are reported by the market module 1030C, to the computer system 1010 of the investor 210 (Step 510). The order module 1030B receives the order 250 (Step 520) from the order module 1020A, i.e., the broker 220, forwards it to the market module 1030C where the order 250 is matched, in whole or in part, with the order of the counterparty (Step 530), and provides the trade status 260, which is reported by the market module 1030C (Step 540), to the trade status module 1020B, i.e., the broker 220. The modules 1030A-C are performed by the computer system 1030 which is programmed with software instructions or programmed in special-purpose hardware to perform the features of the modules 1030A-C. Although not illustrated in FIG. 10, in an exemplary embodiment, the computer system 1030 includes a listing module that is configured to list the financial assets in the market module 1030C.

Although the modules of the functional block diagram 1000 are illustrated in FIG. 10 has having certain connections and are described with respect to FIG. 10 as interacting in certain ways, it is to be understood that such description is not limiting. The computer systems 1010, 1020, and 1030 are contemplated to include other functional blocks, such as communications modules, display modules, etc., interposed between those illustrated in FIG. 10. Further, as discussed above, it is contemplated that, in an exemplary embodiment, the broker 220 operates the trading platform 230. Thus, in such an embodiment, the computer system 1030 is operated by the broker 220. In such an embodiment, the computer system 1020 and 1030 may be the same computer system.

Referring now to FIG. 11, there is illustrated a functional block diagram 1100 for the system 600, in accordance with an exemplary embodiment of the present invention. The functional block diagram 1100 includes a user interface 1110A which operates on a computer system 1110 of the investor 610 in the system 600. It is through this user interface 1110A that the investor 610 (or the computer system 1110 of the investor 610) receives the spot quotes 632A and the hedged quotes 623B, places the order 612, receives the trade status 624, and tenders the currency 614 or the asset 614 at settlement. In an exemplary embodiment, the computer system 1110 includes a trading algorithm 11106 which is programmed into the computer system 1110 to perform one or more of the steps of the method 700. Thus, the computer system 1110 is programmed with the trading algorithm 11106 to perform one or more of the following: receive the spot quotes 632A (Step 720); receive the hedged quotes 632B (Step 710); determine whether to place the order 612 (Step 730); place the order 612 (Step 740); receive the trade status 624 (Step 750); determine whether the order 612 is filled (Step 760); and tender the currency 614 or the asset 614 at settlement (Step 770). It is to be understood that the trading algorithm 11106 may be an automatic trading algorithm that is programmed into the computer system 1110 to perform the decision making performed in the Step 730 and the order placing performed in the Step 740 of the method 700 without intervention by the investor 610.

The functional block diagram 1100 also includes several functional blocks that operate on a computer system 1120 of the broker 620 in the system 600. Specifically, the computer system 1120 includes an order module 1120A, a trade status module 1120B, and a clearing module 1120C, which are programmed to perform respective steps of the method 800. The order module 1120A receives the order 612 from the computer system 1110 investor 610 (Step 810) and forwards it to the trading platform 630 as the order 622 (Step 820). The trade status module 1120B receives the trade status 634 from the trading platform 630 (Step 830) and forwards it to the computer system 1110 of the investor 610 as the trade status 624 (Step 840). The clearing module 1120C receives the trade status 634 and forwards it to the clearing firm 650 as the trade completion details 626 if the trade is complete (Step 850). The trade status module 1120B also receives the tendered asset 614 or the currency 614 from the investor 610 and settles the trade (Step 860). The modules 1120A-C are performed by the computer system 1120 which is programmed with software instructions or programmed in special-purpose hardware to perform the features of the modules 1120A-C.

Finally, the functional block diagram 1100 also includes several functional blocks that operate on a computer system 1130 of the trading platform 630 in the system 600. Specifically, the computer system 1130 includes a currency conversion model module 1130A, a quotes module 1130B, an order module 1130C, and a market module 1130D, which are programmed to perform respective steps of the method 900. The currency conversion model module 1130A receives the real-time currency conversion rates 642 from the FX market 640 (Step 920) and the spot quotes 632A from the market module (Step 910), i.e., the market 670, and generates the hedge quotes 632B (Step 930) using the methods described above. The currency conversion model module 1130A provides the hedge quotes 632 to the computer system 1110 of the investor 610 (Step 940).

The quotes module 1130B provides the spot quotes 632A, which are reported by the market module 1130D, to the computer system 1110 of the investor 610. The order module 1130C receives the order 622 (Step 950) from the order module 1120A, i.e., the computer system 1120 of the broker 620, and forwards it to the currency conversion module 1130A for conversion to the currency in which trades are matched in the market module 1130D, i.e., the market 670. The converted order is provided to the market 670 as the order 662 in currency A. The market module 1130D matches the order 662 the order of the counterparty (Step 960) and provides the trade status 634, which is reported by the market module 1130D (Step 970), to the trade status module 1120B, i.e., the computer system 1120 of the broker 620. Finally, the currency conversion model module 1130A converts currency of the trading platform 630 pursuant to the completed trade (Step 980) and provides the converted-to currency 664 at settlement (Step 990).

The modules 1130A-D are performed by the computer system 1130 which is programmed with software instructions or programmed in special-purpose hardware to perform the features of the modules 1130A-C. Although not illustrated in FIG. 11, in an exemplary embodiment, the computer system 1130 includes a listing module that is configured to list the financial assets in the market module 1130D.

Although the modules of the functional block diagram 1100 are illustrated in FIG. 10 has having certain connections and are described with respect to FIG. 11 as interacting in certain ways, it is to be understood that such description is not limiting. The computer system 1110, 1120, and 1130 are contemplated to include other functional blocks, such as communications modules, display modules, etc., interposed between those illustrated in FIG. 11. Further, as discussed above, it is contemplated that, in an exemplary embodiment, the broker 620 operates the trading platform 630. Thus, in such an embodiment, the computer system 1130 is operated by the broker 620. In such an embodiment, the computer system 1120 and 1130 may be the same computer system.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for trading financial assets on a computer system of a local trading platform in a currency foreign to the local trading platform, the method comprising:
a) providing, by the computer system of the local trading platform, quotes of the financial assets in the foreign currency;
b) receiving, by the computer system of the local trading platform, an order for one or more of the financial assets in the foreign currency; and
c) filling, by the computer system of the local trading platform, the order by matching the order in the foreign currency to one or more counterparty orders in the foreign currency.

2. The method according to claim 1, further comprising:
d) providing, by the computer system of the local trading platform, an indication of a status of the order, the status indicating that the order is filled if the order is matched to the one or more counterparty orders.

3. The method according to claim 2, wherein the step (d) is performed in the computer system, which is programmed to provide the indication of the status of the order.

4. The method according to claim 1, wherein the step (a) is performed by a quotes module, and the computer system of the local trading platform is programmed to provide the quotes of the financial assets in the foreign currency.

5. The method according to claim 1, wherein the step (b) is performed by an order module, and the computer system of the local trading platform is programmed to receive the order for one or more of the financial assets in the foreign currency.

6. The method according to claim 1, wherein the step (c) is performed by a market module, and the computer system of the local trading platform is programmed to fill the order by matching the order in the foreign currency to the one or more counterparty orders.

7. The method according to claim 1, further comprising:
(d) listing the financial assets priced in the foreign currency on the local trading platform.

8. The method according to claim 7, wherein the step (d) is performed by a listing module, and the computer system of the local trading platform is programmed to list the one or more financial assets on the local trading platform.

9. A method for trading, in a first currency, a financial asset priced in a second currency, the first currency different from the second currency, the method comprising:
a) receiving, in a computer system of a trading platform, at least one substantially real-time series of currency conversion quotes for converting between the first currency and the second currency;
b) determining, by the computer system of the trading platform, a hedged quote for the financial asset in the first currency by applying a currency conversion model to the at least one substantially real-time series of currency conversion quotes and a substantially real-time series of quotes for the financial asset priced in the second currency;
c) providing, by the computer system of the trading platform, the hedged quote in the first currency; and
d) receiving an order for the financial asset by the computer system of the trading platform, the order priced in the first currency.

10. The method according to claim 9, wherein the step (b) comprises:
b1) applying, by the computer system, the at least one substantially real-time series of currency conversion quotes to the currency conversion model to estimate a plurality of future currency conversion quotes, the currency conversion model adapted to estimate the plurality of future currency conversion quotes;
b2) determining, by the computer system, an offered conversion price for converting between the first and second currencies within a time window using the plurality of estimated future currency conversion quotes; and
b3) multiplying, by the computer system, a respective quote of the substantially real-time series of quotes for the financial asset by the offered conversion price to determine the hedged quote for the financial asset in the first currency.

11. The method according to claim 10, further comprising:
e) converting, by the computer system, the order for the financial asset priced in the first currency to an order for the financial asset priced in the second currency by applying the offered conversion price to the order priced in the first currency; and
f) identifying, by the computer system, a counterparty order priced in the second currency counter to the order for the financial asset priced in the second currency to fill the order for the financial asset priced in the first currency.

12. The method according to claim 11, wherein the step (f) comprises:
f1) identifying, by the computer system, one or more counterparty orders priced in the second currency counter to the order for the financial asset priced in the second currency; and
f2) filling, by the computer system, the order priced in the first currency by matching the order priced in the second currency to the one or more counterparty orders priced in the second currency.

13. The method according to claim 10, wherein the step (b2) further comprises:
b2a) executing, by the computer system, an algorithm that includes parameters for the plurality of future currency conversion quotes estimated in the step (b1) to determine a best estimated conversion price within the time window; and
b2b) adding, by the computer system, the best estimated conversion price to an associated trade fee to obtain the offered conversion price.

14. The method according to claim 10, wherein:
the step (b1) further comprises estimating, by the computer system, a plurality of risk values associated with the plurality of future currency conversion quotes; and
the step (b2) further comprises executing, by the computer system, an algorithm that includes parameters for the plurality of future currency conversion quotes estimated in the step (b1) and parameters for the plurality of risk values associated with the plurality of future currency conversion quotes to determine a best estimated conversion price within the time window.

15. The method according to claim 9, wherein the order for the financial asset priced in the first currency is a first order, the method further comprising:
e) receiving a second order for the financial asset, the second order priced in a third currency different from the first and second currencies;
f) converting the first order for the financial asset priced in the first currency to a first order for the financial asset priced in the second currency;
g) converting the second order for the financial asset priced in the third currency to a second order for the financial asset priced in the second currency; and
h) filling the first order priced in the first currency by matching the first order priced in the second currency to the second order priced in the second currency.

16. The method according to claim 9, wherein:
the step (b) comprises determining, with the computer system, a substantially real-time series of hedged quotes for the financial asset in the first currency by successively applying a respective one of the at least one substantially real-time series of currency conversion quotes and a respective one of the substantially real-time series of quotes for the financial asset priced in the second currency to the currency conversion model; and
the step (c) comprises providing the substantially real-time series of hedged quotes for the financial asset in the first currency.

17. The method according to claim 16, wherein the step (b) further comprises:
b1) applying, by the computer system, the at least one substantially real-time series of currency conversion quotes to the currency conversion model to estimate a plurality of future currency conversion quotes, the currency conversion model adapted to estimate the plurality of future currency conversion quotes;
b2) determining, by the computer system, a series of offered conversion prices for converting between the first and second currencies within a time window or time windows using the plurality of estimated future currency conversion quotes; and
b3) multiplying, by the computer system, a respective quote in the substantially real-time series of quotes for the financial asset by a respective conversion price in the series of offered conversion prices to determine the substantially real-time series of hedged quotes for the financial asset in the first currency.
